(19) United States
(12) Patent Application Publication
(10) Pub. No.: US 2024/0223851 A1
(43) Pub. Date: Jul. 4, 2024

(54) System And Methods For Recording Viewer Reactions For Concurrent Playback With Original Content

(71) Applicant: Rovi Product Corporation, San Jose, CA (US)

(72) Inventors: Gaurav Gandhi, Bengaluru (IN); Alok Kumar, Bengaluru (IN)

(73) Assignee: Rovi Product Corporation, San Jose, CA (US)

(21) Appl. No.: 18/147,996

(22) Filed: Dec. 29, 2022

(51) Int. Cl. H04N 21/442; H04N 21/4223; H04N 21/431

(52) U.S. Cl. CPC H04N 21/44218; H04N 21/4223; H04N 21/4316

(57) ABSTRACT

A system capable of optimizing a reaction content video and syncing to an original media content. The system may be used to scan a new piece of media content for points of interest. The system may mark those points of interest and trigger recording a reaction during at those points. The system may classify the recorded reactions based on a threshold determined by machine learning technology. The system may output the reaction videos that surpass the threshold to be viewed alongside of the media content during future playbacks.

### BACKGROUND

Streaming services have made it possible to view any of a wide variety of media content at any given time. Reaction videos, where viewers show their instantaneous reaction to content, are a popular form of internet entertainment. However, recording reactions to media content may require large and cumbersome data files as a result of recording oneself reacting to a lengthy piece of content, such as a full-length movie. In this scenario, a user is charged with reviewing the entire file, selecting segments that have interesting reactions and correlating those snippets with the original media content.

Alternatively, the user may preview the media content themselves before recording and then select particular parts to record a reaction. However, with this option the user loses the chance to record the first genuine impression of the media content.

### BRIEF SUMMARY

The present disclosure provides a method and system adapted to optimize recording of viewer reactions to content videos and to embed such recorded reactions in the content videos for simultaneous viewing of the recorded reactions and the content video during subsequent playback of the content video. The system may be used to scan a piece of media content, such as a movie, video clip, etc., for points of interest where a viewer is likely to have a visible and/or audible reaction to the content. The system may tag those points of interest, wherein during playback of the tagged content the tags will trigger recording of a reaction when those points of interest are being played. The system may filter and/or sort the recorded reactions based on one or more thresholds determined. For example, recorded reactions exhibiting a level of visible or audible expression that does not rise to a threshold may be automatically discarded. Recorded reactions exhibiting a level of visible or audible expression that meets or exceeds the threshold may be stored for later playback with the content. For example, they may be embedded in a copy of the content or stored in parallel for synchronized playback with their associated points of interest.

One aspect of the disclosure includes a system comprising an image capture device, a memory, one or more processors in communication with the image capture device and the memory. The one or more processors may be configured to receive media content for playback to one or more viewers, receive tags corresponding to points on interest of the media content, activate the image capture device in response to encountering one of the tags during playback of the media content, receive, via the image capture device, a reaction of the one or more viewers in response to the point of interest corresponding to the one of the tags, and deactivate the image capture device when the point of interest corresponding to one of the tags has ended. The one or more processors may determine a threshold level of reaction appropriate for the corresponding point of interest. The one or more processors may further discard reactions below the threshold level of reaction. The one or more processors may determine the threshold of reaction using machine learning. The one or more processors may also classify the reactions based on a level of reaction.

The system may further be configured wherein the one or more processors are further configured to scan the media content for points of interest, where the scanning comprises using machine learning to predict points within the media content likely to evoke a reaction above a threshold. The one or more processors may be further configured to store the reaction of the one or more viewers. The one or more processors may be further configured to provide for display the reaction to one or more computing devices for simultaneously playback with the media content. The one or more processors may further be configured to selectively limit the reaction content viewable by specific users associated with the one or more computing devices. The one or more processors may further be configured to modify the reaction prior to providing for display by masking or transforming a viewer's appearance in the recorded reaction. The masking or transforming the viewer's appearance comprises matching the recorded reaction to a dynamic image or a static icon configured to mimic reactions of the user. The recorded reaction may include multiple viewers and the one or more processors may be configured to selectively modify one or more viewers without modifying all viewers. The system may further include the providing for display comprising providing the reaction as a picture-in-picture display in the media content or a split screen display with the media content.

Another aspect of the disclosure relates to a method comprising receiving, by one or more processors, media content for play back to one or more viewers, receiving, by the one or more processors, tags corresponding to points of interest of the media content, activating, by the one or more processors, an image capture device in response to encountering one of the tags during playback of the media content, receiving, via the image capture device, a recorded reaction of the one or more viewers in response to the point of interest corresponding to one of the tags, and deactivating the image capture device when the point of interest corresponding to one of the tags has ended. The method may further comprise determining, by the one or more processor, a threshold level of reaction appropriate for the corresponding point of interest, and discarding reaction content below the threshold level of reaction. The method may further comprise storing the recorded reaction of the one or more viewers.

According to some aspects of the disclosure, the method may further comprise providing for display the reaction to one or more computing devices for simultaneous playback with the media content. The method may further comprise selectively limiting the reaction content viewable by specific users associated with the one or more computing devices. The method may further comprise modifying the recorded reaction prior to providing for display by masking or transforming a viewer's appearance in the recorded reaction.

Another aspect of the disclosure relates to a non-transitory computer-readable medium storing instructions executable by one or more processors for performing a method comprising receiving media content for playback to one or more viewers, receiving tags corresponding to points of interest of the media content, activating an image capture device in response to encountering one of the tags during playback of the media content, receiving, via the imaging capture device, a recorded reaction of the one or more viewers in response to the point of interest corresponding to one of the tags, and deactivating, the image capture device when the point of interest corresponding to one of the tags has ended.

### BRIEF DESCRIPTION OF THE DRAWINGS

FIG. 1 is a pictorial diagram of an example system according to aspects of the disclosure.

FIG. 2 is a schematic diagram illustrating predicting points of interest and recording associated reactions according to some examples.

FIG. 3 is another schematic diagram illustrating sorting recorded reaction content based on the level of reaction.

FIG. 4A-E are example representations of output of the system.

FIG. 5 is a flowchart of the method according to aspects of the disclosure.

### DETAILED DESCRIPTION

Aspects of the disclosure provide for a system capable of automatically capturing viewer reactions during moments when content is likely to evoke a visible or audible reaction from the viewer, and syncing the recorded viewer reactions to the original media content. The system may be used to efficiently review a new piece of media content for interesting segments, mark those interesting segments, and trigger recording of a viewer's reaction during those segments. Further, the system may sort the recorded reactions using a reaction analysis module that employs machine learning techniques. The system may output the reaction videos that meet or surpass the threshold to be viewed alongside of the media content during future playbacks.

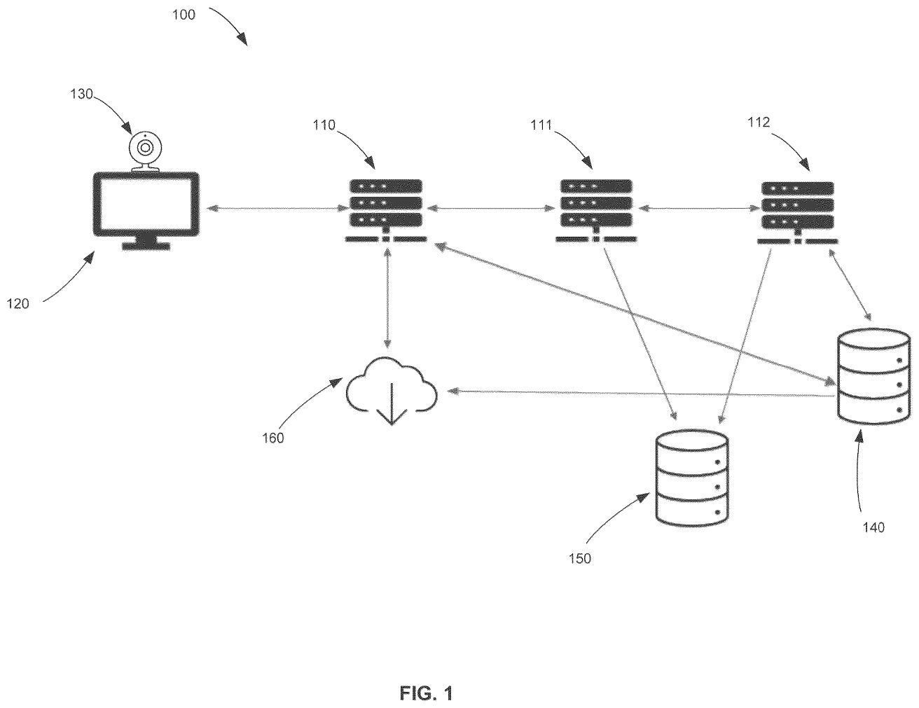

FIG. 1 is a schematic diagram of a system 100 according to aspects of the disclosure. The system 100 may include one or more servers 110-112, a display device 120, a recording device 130, and one or more storage units 140 and 150. The servers 110-112 may be connected to a cloud network 160. The storage units 140 and 150 may also be connected to the cloud network 160.

The servers 110-112 may be standard servers, such as webservers, app servers, encoding servers, or other types of servers. The system may be configured such that the servers 110-112 are communicatively coupled to each other so that data may pass between the various servers. In some examples, multiple servers may be housed within one physical casing. The various illustrative logical blocks and modules described in connection with the embodiments disclosed herein can be implemented or performed by a machine, such as a general purpose server, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose server and processing device can be a microprocessor, but in the alternative, the server can be a controller, microcontroller, or state machine, combinations of the same, or the like. A server can also be implemented as a combination of computing devices, such as a combination of a DSP and a microprocessor, a plurality of microprocessors, one or more microprocessors in conjunction with a DSP core, or any other such configuration.

The display device 120 and/or the recording device 130 can typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the display device 120 and/or the recording device 130 will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

In some examples the display device 120 and the recording device 130 may be the same. For example, a personal computer equipped with a web camera, or a cellular device equipped with a video camera. In some embodiments, the system may have one or more storage means. For example, the system may have dual storage means, as depicted in FIG. 1 as storage units 140 and 150.

The storage units may be video or thumbnail storage 140 and/or metadata database/cache storage 150. In some examples, various types of data may be stored in the same storage means. The data may be stored in computer storage media such as, but not limited to, computer or machine readable media or storage devices such as Bluray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

An example storage medium can be coupled to the server such that the server can read information from, and write information to, the storage medium. In the alternative, the storage medium can be integral to the server. The processor and the storage medium can reside in an application specific integrated circuit (ASIC). Alternatively, the server and the storage medium can reside as discrete components.

Retention of data such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

The network 160, servers 110-112, and any intervening nodes can be interconnected using various protocols and systems, such that the network can be part of the Internet, World Wide Web, specific intranets, wide area networks, or local networks. The network can utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

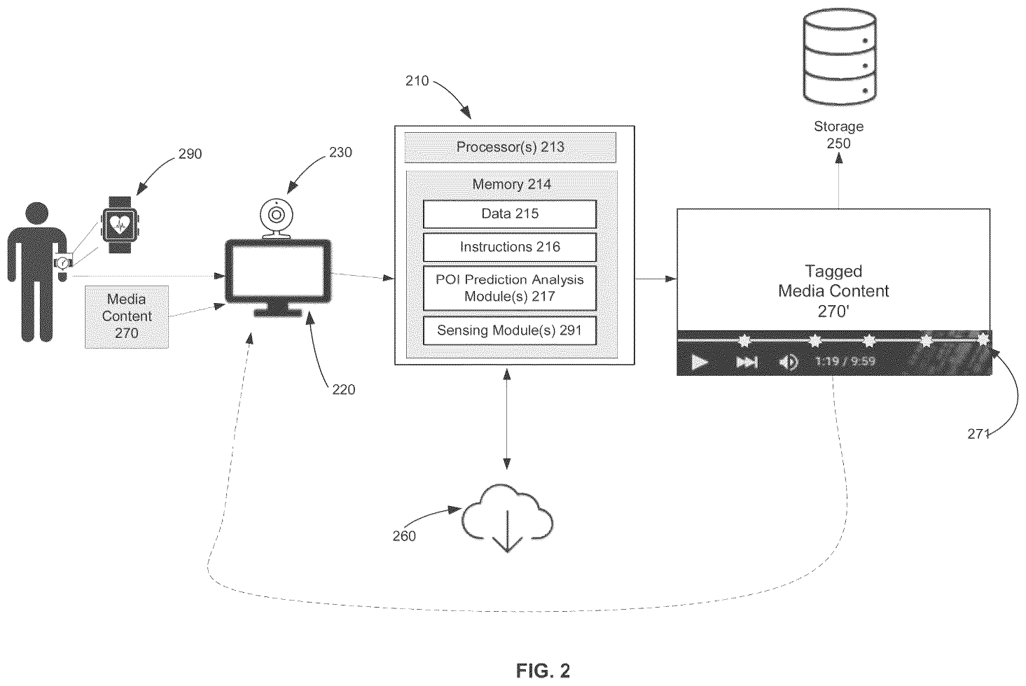

FIG. 2 is a schematic diagram illustrating the process of determining points of interest (“POIs”) within the original media content. The server 210 may be connected to a display device 220, a recording device 230, a storage unit 250 and a cloud network 260. The server 210 may include at least one processor 213, and a memory 214. The memory may further include data 215, instructions 216, at least one POI prediction analysis module 217 and at least one sensing module 291. In some embodiments, the display device 220 and the recording device 230 may be remote from the server 210. For example, the display device 220 may be part of a client computing system, such as a smart television, gaming system, laptop, desktop, handheld computer, or basic display operating in conjunction with a streaming device, etc. The server may also be connected to a biomonitoring device 290, such as a heart rate tracker or a smartwatch. The biomonitoring device may be further connected to a sensing module 291 within the server 210. A user may select original media content 270 to be uploaded to the server 210 of the system. The media content 270 may be a video file having any of a variety of available formats, such as MP4, MOV, WMV, AVI, AVCHD, FLV, F4V, SWF, MKV, WEBM, HTML5, MPEG-2, etc., an image file having any of a variety of available formats, such as JPEG, TIFF, PNG, GIF, PSD, PDF, EPS, AI, INDD, or RAW, etc., an audio file having any of a variety of available formats, such as MP3, AAC, Ogg Vorbis, FLAC, ALAC, WAV, AIFF, DSD, or PCM, etc., or any other digital file.

A POI may be any selected time frame within the length of the media content 270. The POI includes one or more frames within the content wherein a reaction is expected from a viewer. Such POI of the media content 270 may include, but is not limited to, a climactic moment, a shocking sequence of events, a turning point, a sentimental scene, a jump scare, etc. For example, if the media content 270 uploaded was a thriller movie, the POIs can include moments when the audience may feel excitement or suspense, such as when an antagonist mysteriously appears. In another example, if the media content 270 uploaded was home video, the POIs can include moments when there is a drastic change in imagery suggesting a new event is being displayed, or an increase in the volume of the video suggesting lively action. Different pieces of media content may each have a different number of POIs. For example, a thriller movie may have more frequent POIs than a documentary.

In some examples, the POIs may be manually identified by a user that previews the media content 270. The user may personally review or scan the media content 270 and select the frames to be tagged as POIs. For example, the user may view the media content 270 and tag the frames the user considers to be a POI. A user may suggest POIs of the media content 270 for other viewers.

In some examples, the POIs may be tagged using an automated process. As one example, the POIs may be tagged in real time based on biometric readings of a biomonitoring device 290 worn by the user previewing the content. The biomonitoring device may be connected via wired or wireless connection to the server 210. The biomonitoring device 290 may send signals to at least one sensing module 291 within the server 210. For example, when the biomonitoring device 290 detects an increase in heart rate, a sudden body movement, or other biological change corresponding to a potential reaction, a signal may be sent to the sensing module 291 triggering the frames in the content that were playing during the detected biological change to be tagged as POIs.

As another example, POI prediction analysis module 217 may be used to automatically predict POIs based on machine learning techniques. For example, the POI prediction analysis module may be trained using a number of manually tagged POIs in content videos. The POI prediction module may learn to detect POIs in content videos outside of the training set based on comparison to information in the training set, such as patterns or changes in scenery, timing, audio, etc.

According to some examples, the POI prediction analysis module 217 may base its predictions on data accessed via the cloud network 260, such as viewer-specific data. For example, the viewer may grant the POI prediction analysis module 217 access to user information, such as age group, past reactions of the viewer, likes and dislikes of the viewer, other videos viewed by the viewer, etc. Accordingly, the POI prediction analysis module 217 may identify likely POIs specific to the viewer for a given content video based on such user information. Other types of user information may include, for example, biometrics of the viewer from a sensing device worn while the user viewed other videos. Such biometric information may include, for example, heart rates, sleeping patterns, energy levels, etc. Further information considered by the POI prediction analysis module 217 may include current state of the user (e.g., whether the user is focused, distracted, well rested, tired, etc.), the user's watching environment (e.g., whether they are home, in their office, or on a commute, etc.), group information, target audience information (e.g., information about common cultural mannerisms or responses, emotional characteristics, etc.), social context (e.g., current news, pop culture), individual context, survey information, reactions to previous or similar media content, world knowledge (e.g., concepts and relations, logic, facts, current news and events, pop culture, etc.), or any of a variety of other types of information. Any combination of such information may be used to train the POI prediction analysis module 217 to accurately predict POIs for a given content video. All data relating to the user should be explicitly authorized by the user prior to the system's use of such data.

The POI prediction analysis module 217 may be continuously updated, have access and insights about individuals and groups other than the direct user, and have the ability to perform in real-time. The POI prediction analysis module 217 may be a machine learning module with access to a wide range of continuously updated data and modeled reaction behavior, may be enabled with an automated means of determining perception and predicting reaction of a user, where the system is able to learn the patterns it observes in the reactions of audiences of similar media content to predict how a specific media content will be perceived and reacted to. In some embodiments, prediction of perception and reaction of a user may be enabled through models of media content effectiveness and/or impact including general, audience specific, and user-specific modeling, such as trained on a quantity of previously reviewed media content and observed reactions. In some instances, the user may inherit similar reaction properties as groups or audiences they belong to, such as users within a certain age group or similar regional location may share reactions to media content. In such examples, the system may consider a generalized audience predicted reaction to predict how the user may react.

The tagging methods described above may be used individually or in conjunction with other methods. For example, the user may manually tag POI and the server 210 may use the POI prediction analysis module 217 to tag additional POIs.

The determined POI may be stored in storage 250. In some examples, the tags may be applied to the metadata of the media content 270, to create a tagged media content 270′. Once the POIs 271 have been determined, the system may tag the time frames of POI 271 in the metadata of the media content 270. In some examples, there may be a separate application that runs simultaneously with the playback of the media content 270. In some examples, the determined POIs may be stored in association with the separate application, such that these tags may be synchronized with the playback of the media content 270.

The POI 271 tags may trigger the recording device 230 to capture the reaction of the user during the time frame of the POI 271. During the playback of the media content 270, when the POI 271 tags are encountered, the system will start the recording device 230. Once the tagged time frame of the POI 271 has passed, the recording device 230 may stop recording the viewer. Though the recording device 230 is depicted as a web camera, the recording device may be any device that is capable of recording the reaction of a user, such as camera, a web cam, a phone camera, an audio recording device, or any other device or the sort.

According to some examples, detection of POIs may be determined in real-time as the viewer is watching the content video, and recording may be triggered based on the detection without pre-storing information associated with the POIs. For example, as the user watches the playback of the media content 270, sensing module 291 of the server 210 may trigger the recording device 230 to start recording when the biomonitoring device 290 detects a change in the user's biometrics associated with a reaction of the user. For example, if the biomonitoring device 290 detects an elevated heart rate of the user, the sensing module 291 may trigger the recording device 230 to begin recording. Once the heart rate returns to the user's resting heart rate, the sensing module 291 may trigger the recording device to stop recording. The server 210 will save the frames of the media content 270 as POI in the storage 250 and tag the media content 270 accordingly, for future viewing.

According to some examples, output of the prediction analysis module 217 may be evaluated, and such evaluation may be used to update the prediction analysis module 217. For example, recorded reactions that were triggered by the selected POIs may be analyzed to determine whether the predicted POI evoked a reaction above a threshold degree. The results of such analysis may be fed back to the prediction analysis module 217 to fine-tune its predictions.

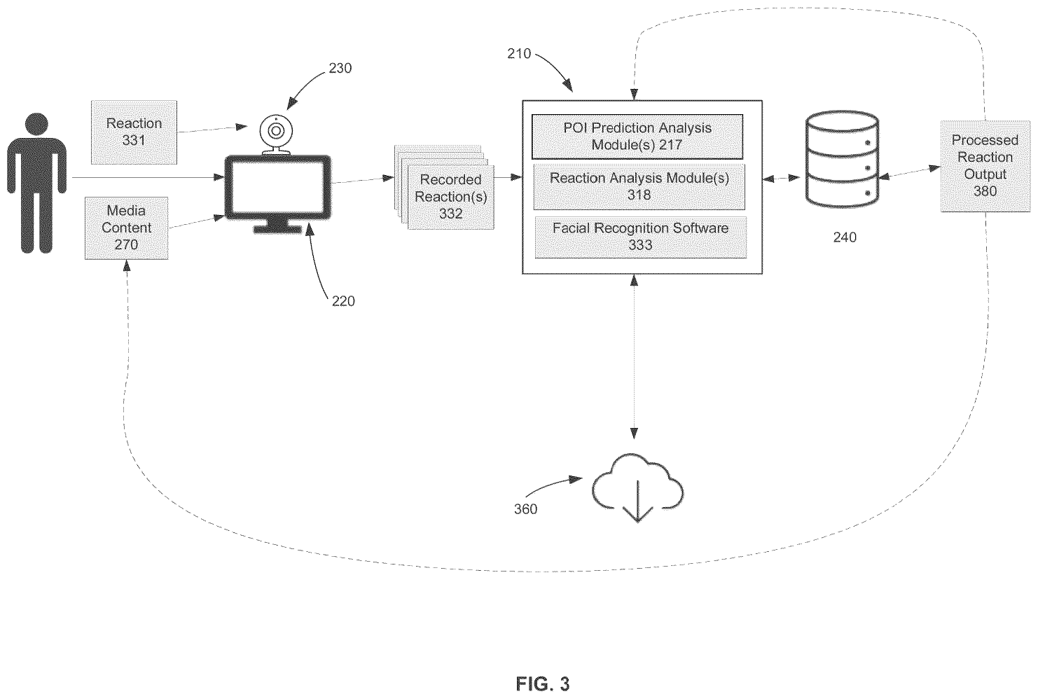

FIG. 3 is a schematic diagram illustrating processing of recorded reaction content, such as analysis, classification, filtering or sorting the recorded reaction content based on a level of reaction. The reaction content may be a video recording, an audio recording, a still image or any other recording capturing the reaction 331 of the viewer. The server 210 in this example may include a reaction analysis module 318 and facial recognition software 333. The reaction analysis module 318 may be trained using machine learning technology to create a hierarchy of levels of reaction, such as a high or low level of reaction, and classify the recorded reaction videos based on the hierarchy. For example, the reaction analysis module 318 may sort a recorded reaction 332 as containing a high level reaction where the user screamed in response to a POI. As another example, the reaction analysis module 318 may sort a recorded reaction 332 as a low level reaction where the user silently watched a POI without change in expression or mood. Although the hierarchy described herein refers to two levels “high” and “low,” it is understood that in other examples, different levels may be used to label levels of reaction according to specifications of the system. There may be more than two levels within the hierarchy of levels of reactions.

The machine learning technology of the reaction analysis module 318 may learn various reactions directly from the user, such as through surveys, prompts, or the like to fill in properties or state preferences, and by observing and analyzing a user's reactions 331 to media content. For example, the user may input favorite movie scenes and indicate their reactions they had to those scenes. In some instances, the user may inherit similar reaction properties as groups or audiences they belong to, such as users within a certain age group or similar regional location may share reactions to media content. In such examples, the system may consider a generalized audience predicted reaction to analyze how the user reacted.

The system may use the reaction analysis module 318 and facial recognition software 333 to classify the recorded reaction content 332 based on the hierarchy of reaction. The reaction analysis module 318 may review the recorded reaction content 332 and analyze the reactions of the user based on the information it has access to. For example, the server 210 may note an increased heart rate and a loud noise in the reaction content during a POI and mark the reaction content as containing a high level reaction. The facial recognition software 333 may scan the recorded reaction content 332 and detect the faces of the user to determine the reactions. For example, the server 310 may detect a user's face and analyze the face for distorted facial expressions signaling a shocked reaction of the user.

The reaction analysis module 318 may use reaction profiles to efficiently analyze the reaction content. The reaction profiles may be built and updated using machine learning technology. The reaction profiles may be initialized with user input through surveys, iterative questions, by analyzing records of prior reactions, etc. Further the data sources of the reaction profiles may include results of researching characteristics of certain populations, user surveys, explicitly stated user preference (e.g. a user-completed part of the user's profile), observed reactions (e.g., sampling aggregated reactions, data extracted through analysis/inference, observed user reaction behavior, etc.), data from biometric sensors (e.g. to track the current state, emotional reactions to various media content, etc.), integrations with other systems holding relevant data, etc.

In some reactions, the reaction profiles may be taken from public and private sources, such as from databases, academic datasets, demographic information (can be inferred by joining the different databases), psychological profiles, author profiling, usage guidelines, relevant data sets (e.g., psychological profiles, demographic data, social media status updates), etc. The reaction profiles may include information about the user, such as their age, gender, race and ethnicity, residential geographic location, professional/work geographic location, current geographic location, geographic location of origin, religious views, political views, personal preferences, contextual emotional states, such as under what conditions the individual experiences general positive emotions, optimism, general negative emotions, depression, anxiety, anger, etc.

The reaction profiles may include generalized representations of typical reactions, such as information extracted from previous viewings of the media content, previous viewings of the reaction content, extracted non-verbal reactions from speech and/or video, such as tone, facial expressions, posture, etc. The reaction profiles may further include received interactions with other systems, such as views, clicks, reaction time, and inputs explicitly reported by a user, such as in the setup or update of a communication profile, through a survey, or use of emoji, inputs reported by a user, and lookalike media content, such as scenes with similar sceneries, such as graveyard or explosions, etc. The reaction profiles may be updated based on the processed reaction output 380, described more fully below.

Further the server 210 may include facial recognition software 333 to assist the classifying module with analyzing the recorded reaction content 332. The facial recognition software 333 may be used by the server 210 to determine how many viewers the recording device 230 captured. In some examples, the system is able to discern between multiple users and analyze their reactions separately. In such an example, the reaction analysis module 318 will sort a recorded reaction 332 based on the reaction of the group of viewers. For example, if the recording device 230 captured a group of three viewers in the recorded reaction content 332, the server 210 may use the facial recognition software 333 to determine the number of viewers. Then, the reaction analysis module 318 may classify the recorded reaction 332 as containing a high level reaction if at least one viewer exhibited a high level of reaction based the reaction profiles.

Once the reaction analysis module 318 has sorted through the recorded reaction content 332, the server may discard any content that was marked as containing low level reaction and send to storage 240 any content that contained a high level reaction.

In some examples, the high level reaction content that is stored in storage 240 for later playback may be processed, such as to be optimized for later playback. For example, such processing may include reducing a length of the recorded video based on which frames in the video exhibit the viewer's reaction, compressing a file size of the video, etc. In further examples, processing the high level reaction content may include modifying the viewer's appearance in the video, applying digital editing techniques, etc. Modifying the viewer's appearance may include, for example, replacing the viewer with an Animoji or avatar, enhancing the viewer's appearance such as by applying filters, etc. Digital editing techniques may include changing color, changing contrast, applying special effects, or any of a variety of other editing techniques. While a few examples of video processing techniques are described above, it should be understood that numerous other available video processing techniques may be applied.

The high level reaction content may be compressed into a thumbnail output or other reduced size output to be played concurrently with the media content for later viewing. In some examples, the user may opt to sort through the recorded reaction content 332 manually and enter input modifying the classifications made by the reaction analysis module 318. For example, a user may review the reaction output and choose only a selected few of the reaction content videos that were marked as high level reaction to save in the processed reaction output video 380. In these examples, the user's input may be used to update the reaction analysis module 318 and inform later classifying decisions.

The system may store the processed reaction output 380 in storage 240. In other examples, the processed reaction output 380 may be saved to the user's computer.

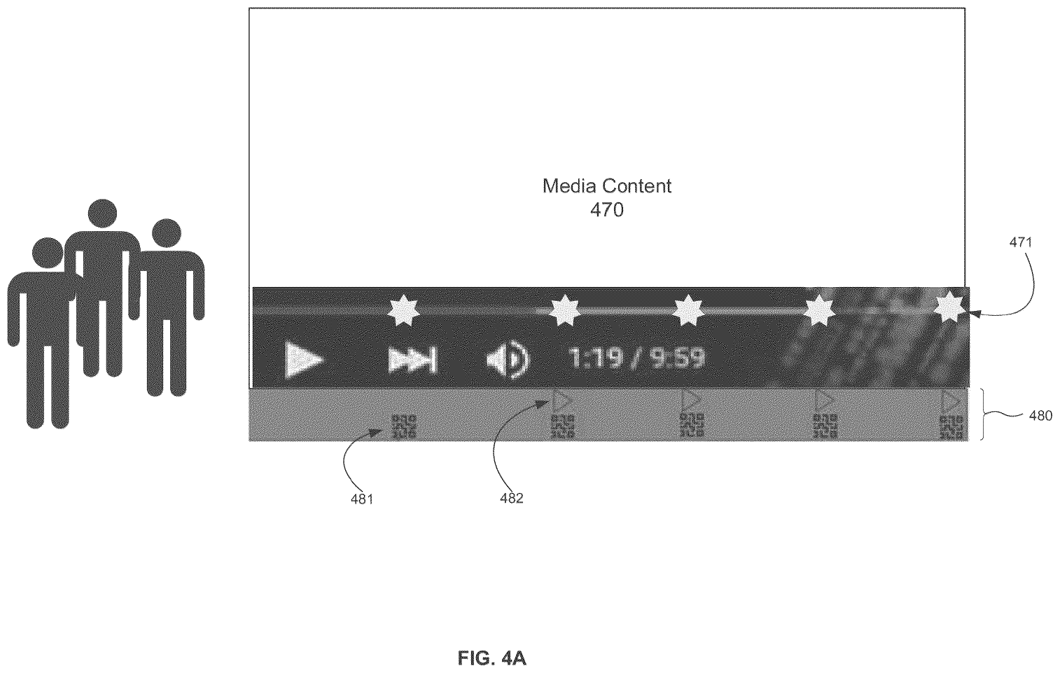

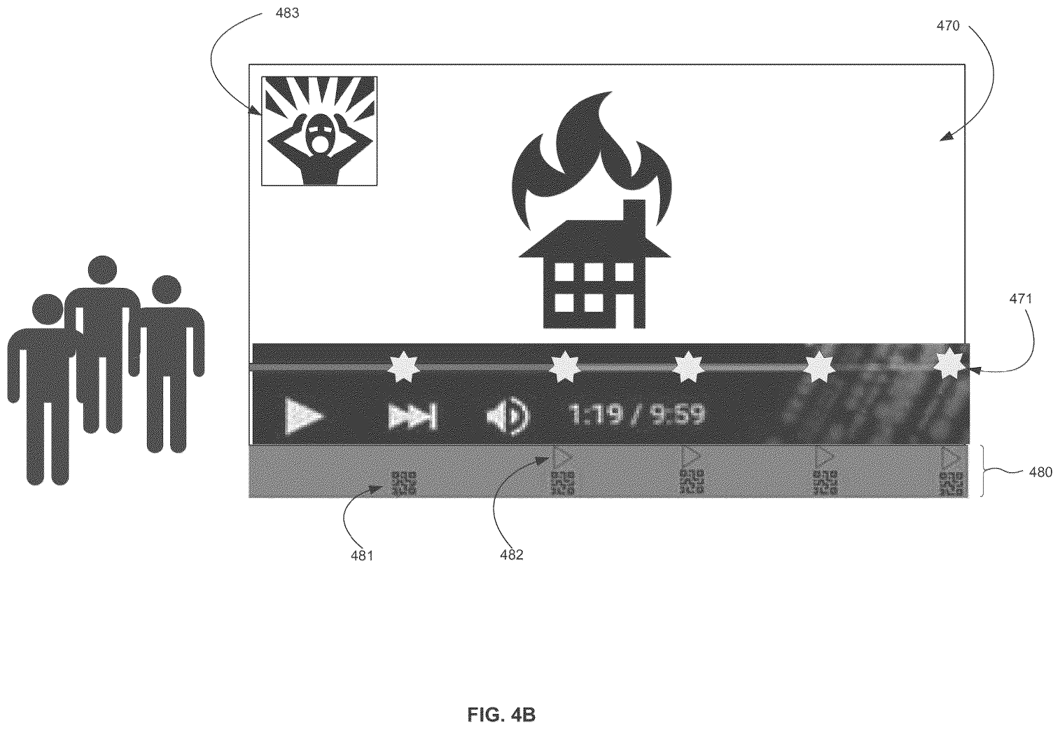

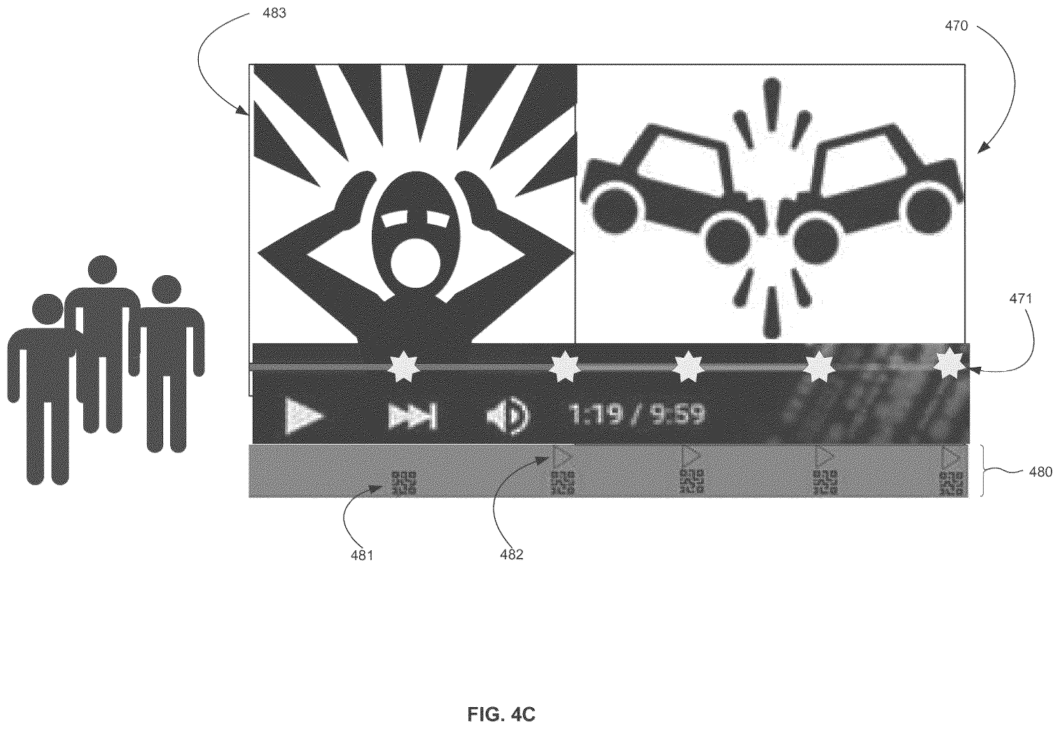

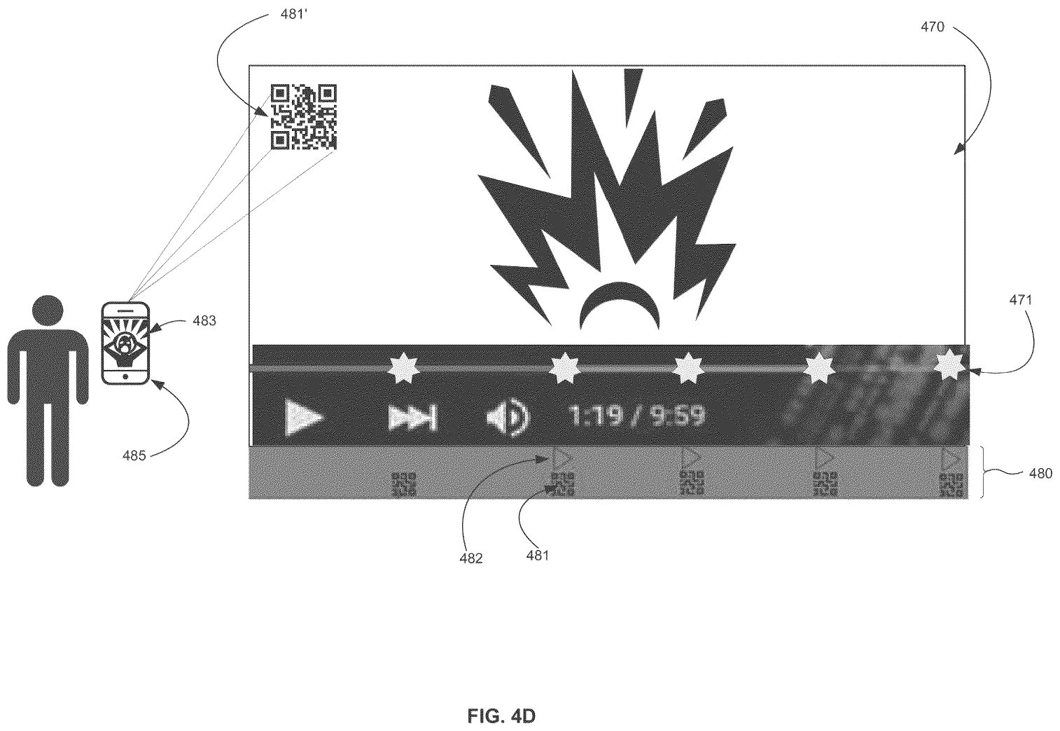

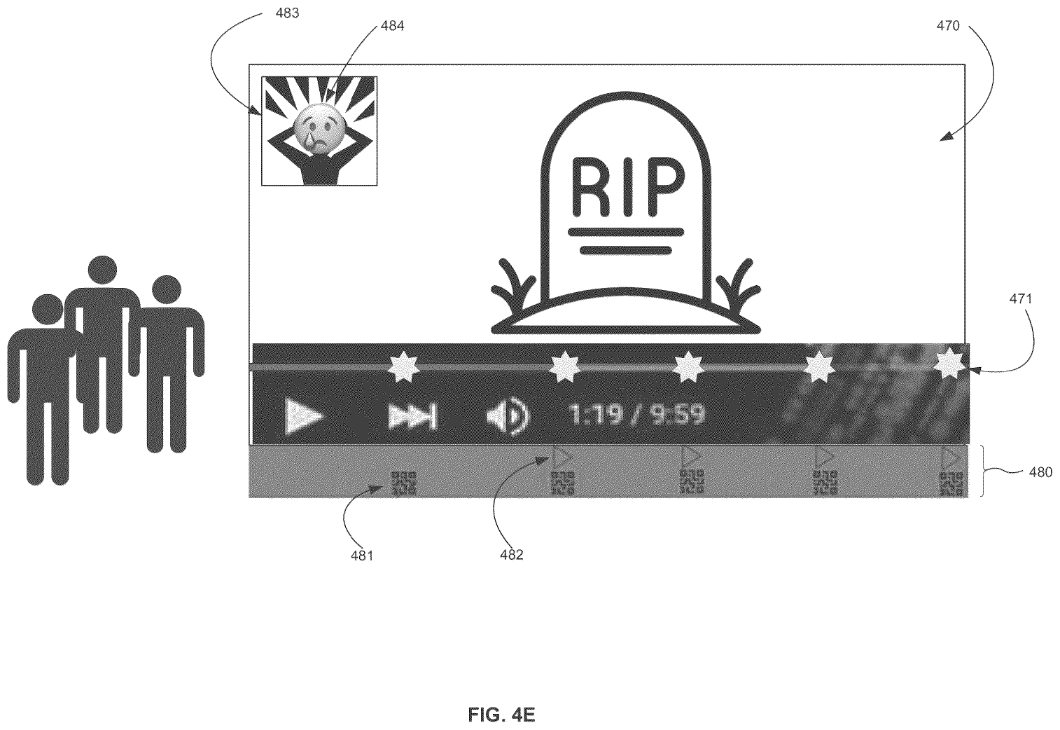

FIGS. 4A-E illustrate example outputs of the video content tagged with recorded reactions corresponding to particular POIs within the video content. FIG. 4A is an example representation of the media content marked with thumbnail reaction output 480. The thumbnail reaction output 480 may contain a compressed video 481 of the high level reaction content and markers 482, which indicate when the compressed video 481 of high level reaction content should be played. For example, the markers 482 may identify a timestamp of the media content 470 at which the compressed video 481 of the high level reaction content should begin playback, a frame of the media content 470 at which the high level reaction content should begin playback, or any other reference that can correlate timing of playback of the media content 470 with timing of playback of the compressed video 481 of the high level reaction content such that the viewer's reactions can be displayed in synch with the corresponding POI. In some examples, the thumbnail reaction output 480 remains as a separate file from the media content 470. In some examples, the thumbnail reaction output 480 may be embedded into the media content 470 file. The markers 482 may be manually selected by the user. For example, the user may preview the thumbnail reaction output 480 and place a marker 482 on the compressed video 481 of the high level reaction content they wish to automatically display during the playback of the media content 470. The reaction profiles may be updated based on the compressed video 481 of the high level reaction content selected to be played by the user. For example, the system may feedback the selections to the server, specifically reaction analysis module, such that the selections may inform the reaction profiles to which reactions the user prefers.

If the user has selected to view a compressed video 481 of the high level reaction content the high level reaction video 483 will appear in a same window or an adjacent window to a window displaying the media content 470. In some examples, as depicted in FIG. 4B, the high level reaction content 483 will appear as a picture-in-picture (PiP) view. In the PiP view, the high level reaction content will appear as a smaller floating window in a corner of the larger media content 470 window. In some examples, the positioning of the PiP may be inverted, such that when a marker 482 is encountered, the system may shrink the media content video into a smaller floating window to be displayed on top of the high level reaction content 483 displayed as the larger window. In some examples, as depicted in FIG. 4C, the system may display the high level reaction content 483 and the media content 470 in an equally distributed manner, such that they two videos are being viewed side by side.

In some examples, the high level reaction video may be triggered when the user actively selects to play the high level reaction content 483 during the playback of the media content 470. For example, the user may click on the compressed video 481 icon for the high level reaction content 483 to view as the media content is playing. If the icon is not clicked, then the high-level reaction content 483 will not play.

FIG. 4D illustrates another possible output of the system. As depicted, in some examples, the thumbnail reaction output may be viewed separately from the media content 470. For example, the thumbnail reaction output 480 may provide a digital icon or barcode 481′, such as a QR code, that corresponds to the compressed video 481 of the high level reaction content. When the compressed video 481 of the high level reaction content is encountered during the playback of the media content 470, the barcode 481′ may become visible to the viewer to scan. If the viewer chooses to scan the barcode 481′, the reaction video may be viewed on a separate display device 485. For example, while viewing the media content 470 synchronized with the thumbnail reaction output 480 on a computer screen, a viewer may scan the barcode 481′ with their phone and view the high level reaction content 483 from their phone with no interruption to the media content 470.

The markers 482 may be changed by the user. For example, the user may select a particular set of high level reaction content to be viewed during the playback of the media content and another set of high level reaction content to be viewed during a second playback. The system may be configured to store the user's selections.

The thumbnail reaction output 480 may be shared beyond the system. The user may select to further compress the file and send to other people. In some examples, the user may choose to automatically share the thumbnail reaction output with a group of predetermined people as soon as the thumbnail reaction output 480 has been created. In some examples, a group watching the same media content 470 separately may combine their individual thumbnail reaction outputs to be viewed simultaneously during a future playback. For example, a group of three viewers may upload and view the same media content in three remote locations and opt to combine their thumbnail reaction outputs, such that when the combined thumbnail reaction output is viewed all three high level reaction content will play simultaneously. In this example, the system may be able to take into consideration the recorded reactions of the remote users and save otherwise low level reaction content wherein at least one viewer of the group had a high level reaction to the POI.

While reaction content may be received from a large number of viewers, the reaction content shared with other users may be limited. For example, while reactions from hundreds of viewers may be received, reactions of a few of those hundreds may be selected for display to other viewers along with the media content. For example, the reactions may be limited based on the most interesting or expressive reactions, authorization settings of the recorded viewers, etc. In some embodiments, viewers may select which reactions to view alongside the media content. For example, viewers can select reactions from particular friends or social media connections, preferred viewers, etc.

FIG. 4E illustrates a possible output of the system. The user may opt to modify the high level reaction content 483 by masking the facial features of the user with a dynamic image or a static icon. The user may review the anticipated output of the system and elect for privacy measures to protect their identity. The system may offer options to mask the facial features or the overall reactions of the user in the recorded reaction content. The system may use facial recognition software to discern the faces of the viewers. The system may identify multiple users within the recorded reaction content. The options may include covering facial features with a mask 484. In some examples, the mask 484 may be a dynamic image, such as an avatar or Animoji. The avatar may mimic the user's reactions, such that the reaction is still understandable to another viewer. The dynamic image may be selected by the user. The dynamic image may be suggested by the system. The user may opt to mask the entire reaction output with the dynamic image or only selected portions of reaction content 483. In some examples, the mask 484 may be a static icon, such as a virtual sticker or emoji icon. The static icon may match the reaction of the user, such that the reaction is still understandable to another viewer. The static icon may be selected by the user. The static icon may be suggested by the system. The user may opt to mask the entire reaction output with the static icon or only selected reaction content 470. In some examples where there are multiple viewers identified in the recorded reaction content 470, the privacy features may be applied to one, some or all of the viewers, to be determined by the user's input. In some examples, the user may opt to modify the high level reaction content 483 by masking or altering the voice of the user or noise of the recorded reaction. For example, the user may opt to mask their voice using voice distortion technology.

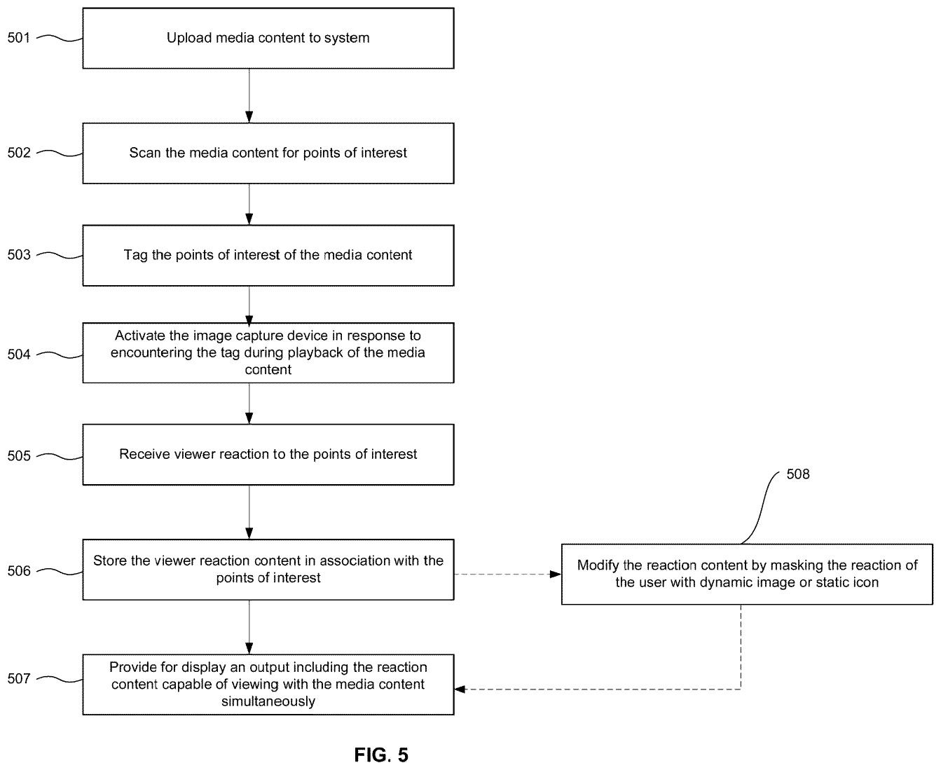

FIG. 5 is a simplified flowchart of the method described herein. The depiction is not intended to limit the order of the steps or teach against repeating certain steps within the same method. In step 501, the media content is selected and uploaded to the system by the user. The media content may be a video file, an image file, an audio file, or any other digital file. The system may be configured to automatically upload any digital file queued to be watched by the user to suggest POI to the user. In some examples, the user may manually upload the files to the system.

In step 502, the system may scan or review the media content for POI. As described above in relation to FIG. 2, the system may employ a ML module within its server to predict segments of the media content that may evoke high levels of reaction for the viewer. The module will use information specific to the user and information obtained through specialized research relating to similar media content and viewer reactions to the same.

In step 503, the system may tag the media content at the determined POI. The tags will mark the time frames for which the system suggests there may be a segment of media content that will evoke a high level of reaction from the user. The tags on the time frames of the POI will trigger a recording device to being recorded for the specified amount of time.

In step 504, the system may send a signal to the recording device when the tag has been encountered, during the playback of the media content. The end of the tag will send a signal to the recording device to cease recording.

In step 505, the system may receive the recorded reaction content recorded during the playback of the media content. The recorded media content may be embedded with metadata that includes a timestamp that corresponds to the POI with which it is associated.

In step 506, the system may store the reaction content associated with the POI to which it corresponds. The system may classify the reaction content based on a determined level of reaction anticipated by the server. If the recorded reaction reaches a threshold of a high level reaction, that recorded reaction may be stored. If the recorded reaction fails to meet the threshold of a high level reaction, the recorded reaction may be deleted. The system's decisions may be overridden by the user at any point.

In step 508, the system may optionally modify the reaction content by masking the facial features of the user with a dynamic image or a static icon. The user may review the anticipated output of the system and elect for privacy measures to protect their identity. The system may offer options to mask the facial features or the overall reactions of the user in the recorded reaction content. The system may use facial recognition software to discern the faces of the viewers. The system may identify multiple users within the recorded reaction content. The options may include covering your facial features with a dynamic image, such as an avatar. The avatar may mimic the user's reactions, such that the reaction is still understandable to another viewer. The dynamic image may be selected by the user. The dynamic image may be suggested by the system. The user may opt to mask the entire reaction output with the dynamic image or only selected reaction content. In some examples, the options may include covering facial features with a static icon, such as a virtual sticker or emoji icon. The static icon may match the reaction of the user, such that the reaction is still understandable to another viewer. The static icon may be selected by the user. The static icon may be suggested by the system. The user may opt to mask the entire reaction output with the static icon or only selected reaction content. In some examples where there are multiple viewers identified in the recorded reaction content, the privacy features may be applied to one, some or all of the viewers, to be determined by the user's input.

In step 507, the system may provide for display an output including the reaction content capable of viewing with media content simultaneously. The output may be delivered as a separate file that is capable of automatically synchronizing with the media content for future playback.

The actions or operations of a method, process, or algorithm described in connection with the embodiments disclosed herein can be embodied directly in hardware, in a software module executed by a server, or in any combination of the two. The software module can be contained in computer-readable media that can be accessed by a server. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system, or be part of multiple systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

1. A system comprising:
an image capture device;
a memory;
one or more processors in communication with the image capture device and the memory, the one or more processors configured to:
receive media content for playback to one or more viewers;
receive tags corresponding to points of interest of the media content, wherein the tags are automatically determined using a machine learning model trained based on biometric readings of a biomonitoring device worn by a user and historical information related to the user's past reactions to similar media content;
activate the image capture device in response to encountering one of the tags during playback of the media content;
receive, via the image capture device, a recorded reaction of the one or more viewers in response to the point of interest corresponding to the one of the tags; and
deactivate the image capture device when the point of interest corresponding to one of the tags has ended.

2. The system of claim 1, wherein the one or more processors determine a threshold level of reaction appropriate for the corresponding point of interest.

3. The system of claim 2, wherein the one or more processors discard the recorded reactions below the threshold level of reaction.

4. The system of claim 2, wherein the one or more processors determine the threshold of level of reaction using machine learning.

5. The system of claim 1, wherein the one or more processors classify the recorded reactions based on a level of reaction.

6. The system of claim 1, wherein the one or more processors are further configured to scan the media content for points of interest, the scanning comprising using machine learning to predict points within the media content likely to evoke a reaction above a threshold.

7. The system of claim 1, wherein the one or more processors are further configured to store the recorded reaction of the one or more viewers.

8. The system of claim 1, wherein the one or more processors are further configured to provide for display the recorded reaction to one or more computing devices for simultaneous playback with the media content.

9. The system of claim 8, wherein the one or more processors are further configured to selectively limit the recorded reaction viewable by specific users associated with the one or more computing devices.

10. The system of claim 8, wherein the one or more processors are further configured to modify the reaction prior to providing for display by masking or transforming a viewer's appearance in the recorded reaction.

11. The system of claim 10, wherein the masking or transforming the viewer's appearance comprises matching the recorded reaction to a dynamic image or a static icon configured to mimic reactions of the user.

12. The system of claim 10, wherein the recorded reaction includes multiple viewers, and wherein the one or more processors are configured to selectively modify one or more viewers without modifying all viewers.

13. The system of claim 8, wherein the providing for display comprises providing the recorded reaction as a picture-in-picture display in the media content or a split-screen display with the media content.

14. A method comprising:
receiving, by one or more processors, media content for playback to one or more viewers;
receiving, by the one or more processors, tags corresponding to points of interest of the media content, wherein the tags are automatically determined using a machine learning model trained based on biometric readings of a biomonitoring device worn by a user and historical information related to the user's past reactions to similar media content;
activating, by the one or more processors, an image capture device in response to encountering one of the tags during playback of the media content;
receiving, via the image capture device, a recorded reaction of the one or more viewers in response to the point of interest corresponding to one of the tags; and
deactivating the image capture device when the point of interest corresponding to one of the tags has ended.

15. The method of claim 14, further comprising determining, by the one or more processors, a threshold level of reaction appropriate for the corresponding point of interest, and discarding reaction content below the threshold level of reaction.

16. The method of claim 14, further comprising storing the recorded reaction of the one or more viewers.

17. The method of claim 14, further comprising providing for display the reaction to one or more computing devices for simultaneous playback with the media content.

18. The method of claim 17, further comprising selectively limiting the recorded reaction viewable by specific users associated with the one or more computing devices.

19. The method of claim 17, further comprising modifying the reaction prior to providing for display by masking or transforming a viewer's appearance in the recorded reaction.

20. A non-transitory computer-readable medium storing instructions executable by one or more processors for performing a method, comprising:
receiving media content for playback to one or more viewers;
receiving tags corresponding to points of interest of the media content, wherein the tags are automatically determined using a machine learning model trained based on biometric readings of a biomonitoring device worn by a user and historical information related to the user's past reactions to similar media content;
activating an image capture device in response to encountering one of the tags during playback of the media content;
receiving, via the image capture device, a recorded reaction of the one or more viewers in response to the point of interest corresponding to one of the tags; and
deactivating the image capture device when the point of interest corresponding to one of the tags has ended.
